(19) United States
(12) Patent Application Publication
(10) Pub. No.: US 2026/0171608 A1
(43) Pub. Date: Jun. 18, 2026

(54) SEPARATOR FOR LITHIUM SECONDARY BATTERY, METHOD FOR MANUFACTURING THE SAME, AND LITHIUM SECONDARY BATTERY COMPRISING THE SAME

(71) Applicants: HYUNDAI MOTOR COMPANY, Seoul (KR); KIA CORPORATION, Seoul (KR); UIF (University Industry Foundation), Seoul (KR)

(72) Inventors: Youngjoon Roh, Hwaseong-si (KR); Junki Rhee, Hwaseong-si (KR); Suhwan Kim, Seoul (KR); Seungyeop Choi, Seoul (KR); Yong Min Lee, Seoul (KR); Jun Pyo Seo, Seoul (KR)

(73) Assignees: HYUNDAI MOTOR COMPANY, Seoul (KR); KIA CORPORATION, Seoul (KR); UIF (University Industry Foundation), Seoul (KR)

(21) Appl. No.: 19/098,641

(22) Filed: Apr. 2, 2025

(30) Foreign Application Priority Data
Dec. 17, 2024 (KR) 10-2024-0188522

(51) Int. Cl. H01M 50/457; H01M 10/052; H01M 10/42; H01M 50/403; H01M 50/417; H01M 50/426; H01M 50/431; H01M 50/434; H01M 50/446; H01M 50/451; H01M 50/491; H01M 50/497

(52) U.S. Cl. CPC H01M 50/457; H01M 10/052; H01M 10/4235; H01M 50/403; H01M 50/417; H01M 50/426; H01M 50/431; H01M 50/434; H01M 50/446; H01M 50/451; H01M 50/491; H01M 50/497

(57) ABSTRACT

A separator for a lithium secondary battery comprising a thermally conductive material and a lithium-affinitive material, a method for manufacturing the same, and a lithium secondary battery comprising the same.

### CROSS-REFERENCE TO RELATED APPLICATIONS

This application claims the benefit of priority to Korean Patent Application No. 10-2024-0188522, filed on Dec. 17, 2024, in the Korean Intellectual Property Office, the entire disclosure of which is incorporated herein by reference.

### FIELD

The present disclosure relates to a separator for a lithium secondary battery comprising a thermally conductive material and a lithium-affinitive material, a method for manufacturing the same, and a lithium secondary battery comprising the same.

### BACKGROUND

Lithium batteries are widely used, from small electronic devices to large energy storage systems based on their high energy density and excellent life characteristics. In particular, with the spread of high-performance applications such as an electric vehicle and an energy storage device (ESS), the demand for the development of lithium batteries, especially lithium secondary batteries that have high output, high energy density, and improved safety is continuously increasing.

Since lithium metal has a low redox potential of −3.045 V (vs Li/Li+) and a very large theoretical capacity of 3,860 mAh g⁻¹, lithium metal is attracting attention as a next-generation anode material. However, lithium dendrites are formed and grow during the charge and discharge process of the lithium metal anode, which increases the risk of internal short circuits in a battery, and the charge and discharge efficiency is reduced due to the repeated formation and decomposition of a solid electrolyte interface (SEI) layer.

Therefore, in order to solve this problem, a technical approach has been recently made to apply an anode protective coating layer to suppress dendrite growth or to apply a coating to the separator. In addition, many methods have been attempted to effectively manage heat generation by introducing an additional thermally conductive layer inside the battery. Although these methods have shown some success, problems have occurred in which an energy density is lowered and cell efficiency and performance are degraded due to the introduction of additional components. In addition, there are still limitations in that components such as a coating layer are damaged during the repeated charge and discharge processes or thermal conductivity characteristics are not sufficiently secured.

Accordingly, there is a need to develop new technologies that may efficiently manage heat generation inside the battery, suppress lithium dendrite growth, and simultaneously improve cell performance.

### SUMMARY

An aspect of the present disclosure is to provide a separator for a lithium secondary battery having excellent safety and electrochemical characteristics, comprising a thermally conductive material and a lithium-affinitive material, a method for manufacturing the same, and a lithium secondary battery comprising the same.

In embodiments of this aspect, the present disclosure provides a separator for a lithium secondary battery, comprising: a porous substrate; a first coating layer coating at least a portion of the porous substrate; and a second coating layer coating at least a portion of the first coating layer.

According to an example embodiment of the present disclosure, the first coating layer may comprise a thermally conductive material, and the second coating layer may comprise a lithium-affinitive material.

Another aspect of the present disclosure provides a lithium secondary battery comprising the separator for a lithium secondary battery according to various aspects and embodiments of the present disclosure

Still another aspect of the present disclosure provides a method for manufacturing a separator for a lithium secondary battery, comprising: forming a first coating layer on a porous substrate; and forming a second coating layer on the first coating layer.

In example embodiments, the first coating layer may comprise a thermally conductive material, and the second coating layer may comprise a lithium-affinitive material.

It has been found that the separator for a lithium secondary battery according to the present disclosure can reduce the local temperature rise by comprising the thermally conductive material. In addition, this can suppress any internal short circuit that may be associated with heat shrinkage through improved heat resistance.

It has also been found that the separator for a lithium secondary battery according to the present disclosure can induce lithium plating onto the lithium-compatible material by comprising the lithium-affinitive material. Accordingly, it is possible to reduce resistance by providing for nucleation site(s). In addition, it is possible to prevent dendrite the growth and any internal short circuit that may be associated with dendrite growth.

Accordingly, in some embodiments the separator for a lithium secondary battery according to the present disclosure, can effectively release heat generated inside the battery during the overcharge or high-speed charge/discharge by forming the thin coating layer on the porous substrate, thereby suppressing the ignition and deterioration of the battery.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a schematic diagram illustrating a first coating layer formation step;

FIG. 2 is a schematic diagram illustrating a second coating layer formation step;

FIG. 3 is an SEM image illustrating an embodiment according to Experimental Example 1;

FIG. 4 is a graph illustrating an embodiment of thickness measurement results according to Experimental Example 2;

FIG. 5 is a graph illustrating an embodiment of electrochemical characteristics according to Experimental Example 2;

FIG. 6 is an image illustrating an embodiment of thermal conductivity characteristics according to Experimental Example 3; and

FIG. 7 is a graph illustrating an embodiment of electrochemical characteristics according to Experimental Example 4.

### DETAILED DESCRIPTION

Unless indicated otherwise, it is to be understood that all the terms used herein comprising technical and scientific terms have the same meaning as those generally understood by those skilled in the art to which the present disclosure pertains. It should also be understood that the terms used throughout the disclosure generally have their common meanings as used in a dictionary and any particular meanings within the context of the related art, unless clearly defined otherwise herein.

In the present application, the terms such as ‘first’ and ‘second’ may be used to describe various components, but these components are not to be interpreted to be limited to these terms. The terms are used only to distinguish one component from another component. For example, the first component may be named the second component and the second component may also be similarly named the first component, without departing from the scope of the present disclosure (i.e., that separate components are identified in some manner).

Terms used in the present specification are used only in order to describe specific exemplary embodiments rather than limiting the present disclosure. Singular forms include plural forms unless the context clearly indicates otherwise. It will be understood that the terms “includes” or “have” or “comprises” used in this specification, specify the presence of stated features, numerals, steps, operations, components, parts mentioned in this specification, or a combination thereof, but do not preclude the presence or addition of one or more other features, numerals, steps, operations, components, parts, or a combination thereof. Those terms will also be understood to encompass transitional terms such as “consisting of” and “consisting essentially of” which can be used to specify the presence of the stated feature(s) and minor amounts of other components or features that do not have any substantial effect on the operability of the embodiments, and/or can be used to specify the presence of the stated feature(s) only, to the exclusion of any additional feature(s).

In an aspect, a separator for a lithium secondary battery of the present disclosure may comprise a porous substrate 10, a first coating layer 20 coating at least a portion of the porous substrate 10, and a second coating layer 30 coating at least a portion of the first coating layer 20.

In embodiments, the porous substrate 10 may comprise a polyolefin material. The polyolefin material may be a polypropylene (PP) material or a polyethylene (PE) material.

In embodiments, the porous substrate 10 of the present disclosure may comprise pores of a size that can serve as passages for lithium ions while preventing electrical short-circuiting between a cathode and an anode.

In one example embodiment, the porous substrate 10 of the present disclosure may have a porosity of 30 to 80%. In some preferred embodiments, the porosity may be 40 to 70%. Meanwhile, any method known in the art can be used to determine the above porosity

In embodiments, the porous substrate 10 of the present disclosure may have a thickness of 3 to 30 μm. In some preferred embodiments, the porous substrate may have a thickness of 5 to 10 μm.

In embodiments, the first coating layer 20 may be coating at least a portion of a surface of the porous substrate 10. In some embodiments, the first coating layer 20 may be coating a majority of a surface of the porous substrate 10. In some further embodiments, the first coating layer 20 may be coating substantially all or all of a surface of the porous substrate 10. In embodiments, the first coating layer 20 of the present disclosure may comprise a thermally conductive material.

In embodiments of the present disclosure any material having thermal conductivity may be used as the thermally conductive material. In some further embodiments, the thermally conductive material may comprise any one or more of, or may be selected from the group consisting of, aluminum nitride (AlN), boron nitride (BN), silicon nitride (Si₃N₄), magnesium nitride (Mg₃N₄), silicon carbide (SiC), beryllium oxide (BeO), aluminum oxide (Al₂O₃), aluminum (Al), silver (Ag), gold (Au), copper (Cu), and/or nickel (Ni).

In embodiments, the thermally conductive material may have a thermal conductivity of 20 W/m·K or more. In some example embodiments, the thermally conductive material may be aluminum nitride (AlN). In such embodiments, a particle size of the aluminum nitride may be 1 to 4 μm and, in some preferred embodiments, the aluminum nitride particle size may be 1.2 to 2 μm.

In embodiments of the present disclosure, a sufficient thermal conductivity can be obtained and prevent local temperature rise of the separator. Accordingly, in some embodiments of the present disclosure, the first coating layer 20 may have a thickness of 1 to 10 μm and, in some preferred embodiments, may have a thickness of 2 to 5 μm.

In embodiments of the present disclosure, the second coating layer 30 may be coating at least a portion of the first coating layer 20. In some embodiments, the second coating layer 30 may be coating a majority of a surface of the first coating layer 20. In some further embodiments, the second coating layer 30 may be coating substantially all or all of a surface of the first coating layer 20. In embodiments, the second coating layer 30 of the present disclosure may comprise a lithium-affinitive material.

In some further embodiments, the lithium-affinitive material may be a material that is highly reactive with lithium, and may be a material that forms and/or induces uniform lithium metal layering by minimizing nucleation resistance in the process of reducing lithium ions to lithium metal.

According to an embodiment of the present disclosure, the lithium-affinitive material may comprise any one or more of, or may be selected from the group consisting of, gold (Au), silver (Ag), platinum (Pt), zinc (Zn), silicon (Si), magnesium (Mg), copper oxide (CuO), zinc oxide (ZnO), cobalt oxide (CoO), and/or manganese oxide (MnO).

According to an embodiment of the present disclosure, the second coating layer 30 may have a thickness of 10 to 100 nm. In such embodiments, the second coating layer 30 of the present disclosure may be formed in the above range, and may not affect the energy density of the battery, in contrast to state of the art batteries. In addition, it is possible to effectively release heat generated during the overcharge or high-speed charge/discharge. In this way, the disclosure enables the possibility to suppress the ignition and deterioration of the battery. In addition, it is possible to reduce resistance by providing the nucleation site.

In accordance with these embodiments, the separator for a lithium secondary battery of the present disclosure, which comprises the porous substrate 10, the first coating layer 20, and the second coating layer 30, may have a thickness of 8 to 15 μm and an ion conductivity of 0.550 to 0.710 mS cm⁻¹.

In some aspects, the disclosure provides a lithium secondary battery comprising the separator for a lithium secondary battery according to the various embodiments described above and throughout the descriptions herein. In embodiments, the lithium secondary battery of the present disclosure can exhibit excellent battery life and rate characteristics by efficiently controlling internal heat generation.

In an aspect, the disclosure provides a method for manufacturing a separator for a lithium secondary battery as described herein, and comprises (S100) forming a first coating layer on a porous substrate; and (S200) forming a second coating layer on the first coating layer.

In embodiments, the method for manufacturing a separator for a lithium secondary battery of the present disclosure, the porous substrate, the first coating layer, and the second coating layer comprise the same materials as those described above in the aspects and embodiments relating to the separator materials.

In embodiments, the forming (S100) of the first coating layer 20 on the porous substrate of the present disclosure may be performed by bar coating a mixture comprising a binder, a solvent, and the thermally conductive material on the porous substrate.

In embodiments, the binder may comprise any one or more of, or may be selected from the group consisting of, polyvinylidene fluoride (PVDF), styrene butadiene rubber (SBR), and/or carboxy methyl cellulose (CMC), or combinations thereof.

In embodiments, the solvent may comprise any one or more of, or may be selected from the group consisting of, N-methyl pyrrolidone (NMP), isopropyl alcohol (IPA), and/or water.

In one example embodiment, the binder may be polyvinylidene fluoride (PVDF), and the solvent may be N-methyl pyrrolidone (NMP).

In some embodiments of the present disclosure, the mixture may comprise the thermally conductive material and the binder in a mass ratio of 8:1 to 10:1 (conductive material:binder).

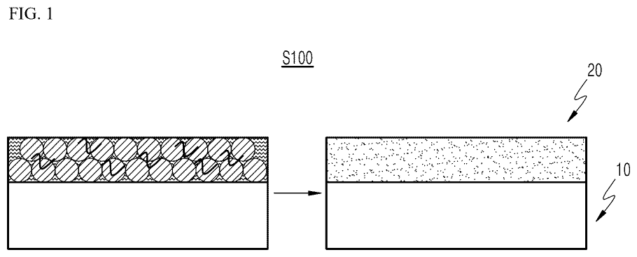

The forming of the first coating layer from the mixture as described above is illustrated in FIG. 1. In FIG. 1, the thermally conductive material, the binder, and the solvent are arbitrarily illustrated, expressed, and identified, and the thicknesses and lengths of the separator and the first coating layer are also arbitrarily illustrated, expressed, and identified, and are not limited to any specific form or scale, as depicted.

The forming (S200) of a second coating layer on the first coating layer of the present disclosure may be performed through a sputtering process. The sputtering may be a physical vapor deposition (PVD) process, and in one example, may be a radio frequency (RF) sputtering process. For clarity, RF sputtering refers to a method for generating plasma on a target surface using high-frequency power, detaching a target material at an atomic level while ions in the plasma collide with the target, and then depositing the detached material on a substrate. In accordance with the aspects and embodiments relating to the separator, when applied the first and/or second coating layers can be formed on a least a portion of the surface of the substrate or the coating layer on which it is being applied. In further embodiments the first and/or second coating layers, when applied, can be formed on a least a majority of the surface of the substrate or the coating layer on which it is being applied, or in further embodiments can be formed on substantially all or all of the surface of the substrate or the coating layer on which it is being applied.

In the present disclosure, the sputtering process may use the lithium-affinitive material as the target material and may be performed at an output of 10 to 20 W.

In one example embodiment, the forming (S200) of a second coating layer on the first coating layer of the present disclosure may be performed so that the resulting thickness ranges from 10 to 100 nm.

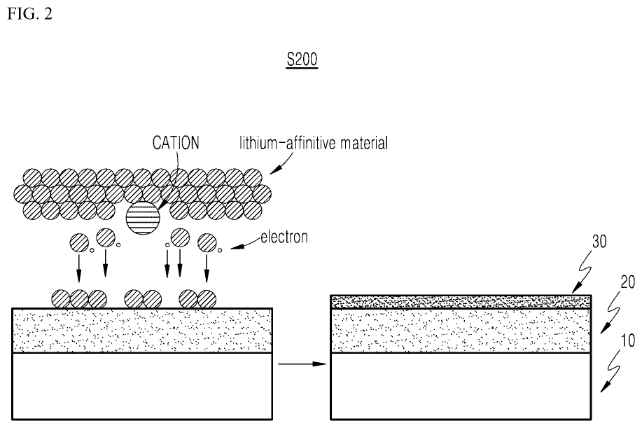

The forming (S200) of a second coating layer on the first coating layer according to some embodiments described above is illustrated in FIG. 2. In FIG. 2, the lithium-affinitive material, the electron, and the cation are arbitrarily illustrated, expressed, and identified, and the thicknesses and lengths of the separator, the first coating layer, and the second coating layer are also arbitrarily illustrated, expressed, and identified, and are not limited to any specific form or scale, as depicted.

Hereinafter, the present disclosure will be described in more detail through the following examples and experimental descriptions, which serve only to illustrate aspects and embodiments of the present disclosure in more detail. It will be understood that the scope of the present disclosure is not limited by the following examples and experimental descriptions.

### Example 1

In order to manufacture a first coating layer coating at least a portion of a porous substrate, aluminum nitride (AlN), a polyvinylidene fluoride (PVdF) binder, and an N-methyl pyrrolidone (NMP) solvent were mixed. In this example, the aluminum nitride with a particle size of 1.4 μm was used, and the aluminum nitride and PVdF binder were mixed in a mass ratio of 9:1.

The manufactured mixture was coated on the porous substrate through bar coating. In this example, the porous substrate comprises a polyethylene material and had a thickness of 8.6 μm.

Next, in order to form the second coating layer, the porous substrate on which the first coating layer was formed was fixed on the substrate of an RF-Sputter device equipped with an Ag target.

In the sputtering process, when the pressure inside the chamber of the RF-Sputter became 2×10⁻⁵ Torr or less, argon (Ar) gas was injected to maintain the working pressure at 7×10⁻³ Torr.

Thereafter, Ag was deposited on the upper surface of the first coating layer for 1 minute at an output of 10 W to form a second coating layer, and providing the separator for a lithium secondary battery.

### Comparative Example 1

After preparing the same porous substrate as in Example 1, a separator for a lithium secondary battery was prepared without applying the first coating layer or the second coating layer.

### Comparative Example 2

A separator for a lithium secondary battery comprising a porous substrate and a first coating layer was manufactured in the same manner as in Example 1, except that the second coating layer was not applied.

### Comparative Example 3

After preparing the same porous substrate as in Example 1, the second coating layer was formed without forming the first coating layer. In this example, the second coating layer was formed in the same manner as in Example 1, except that Ag was deposited on the upper surface of the porous substrate for 1 minute at an output of 20 W. The separator for a lithium secondary battery comprising a porous substrate and a second coating layer was manufactured.

### Comparative Example 4

A separator for a lithium secondary battery was manufactured in the same manner as in Comparative Example 3, except that Ag was deposited on the upper surface of the porous substrate for 1 minute at an output of 15 W when forming the second coating layer.

### Comparative Example 5

A separator for a lithium secondary battery was manufactured in the same manner as in Comparative Example 3, except that Ag was deposited on the upper surface of the porous substrate for 1 minute at an output of 10 W when forming the second coating layer.

### Experimental Example 1

In this experiment, the properties of the separators according to the Examples and Comparative Examples were analyzed.

The thicknesses of the separators according to the Examples and Comparative Examples were measured, and the air permeability, resistance, and ionic conductivity were measured.

The air permeability of the separators according to the Examples and Comparative Examples was measured using a densometer, which is an air permeability measuring device, to measure the time required for 100 ml of air to pass through.

The resistance and ionic conductivity of the separators according to the Examples and Comparative Examples were calculated by measuring the bulk resistance after manufacturing the coin cell composed of stainless steel (SUS) as SUS/separator/SUS.

The results of the measured properties are shown in Table 1 below.

TABLE 1

| | Thickness of | | | Ionic |
|---|---|---|---|---|
| | separator | Air permeability | Resistance | conductivity |
| | (μm) | (sec 100 mL⁻¹) | (Ohm) | (mS cm⁻¹) |
| Example 1 | 11 | 198.9 | 0.836 | 0.655 |
| Comparative | 8.6 | 127.0 | 0.987 | 0.433 |
| Example 1 | | | | |
| Comparative | 11 | 190.3 | 0.858 | 0.639 |
| Example 2 | | | | |
| Comparative | 8.6 | 126.5 | 1.153 | 0.441 |
| Example 3 | | | | |
| Comparative | 8.6 | 132.6 | 0.930 | 0.475 |
| Example 4 | | | | |
| Comparative | 8.6 | 127.8 | 0.968 | 0.462 |
| Example 5 | | | | |

Referring to Table 1, Example 1, which comprises both the first coating layer and the second coating layer, has the lowest resistance value of 0.836 Ohm and an excellent ionic conductivity of 0.655 mS cm⁻¹.

In the case of Comparative Example 2, it had a thickness of about 11 μm similar to Example 1, comprising the first coating layer, and had also higher ionic conductivity than Comparative Examples 1, 3 to 5. However, Comparative Example 2 showed lower ionic conductivity and higher resistance relative to Example 1, which also comprises the second coating layer. Thus, the data indicates that the second coating layer may affect the electrical characteristics of the separator.

Reviewing Comparative Examples 1, 3 to 5, the air permeability and ionic conductivity were for each were much lower relative to Example 1, and the resistance of each was also high.

Thus, the data shows that the separator for a lithium secondary battery in accordance with example embodiments of the disclosure having a first coating layer comprising the thermally conductive material provides excellent results in terms of the ionic conductivity.

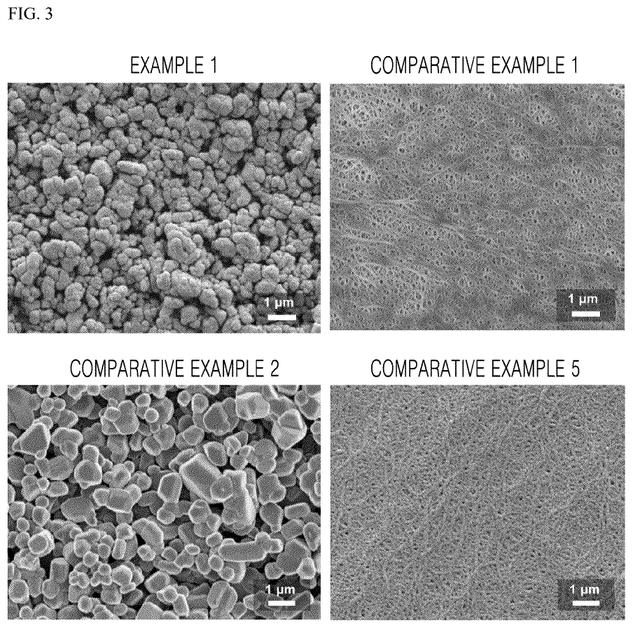

Next, the SEM images of Example 1, Comparative Example 1, Comparative Example 2, and Comparative Example 5 were obtained and are illustrated in FIG. 3.

Referring to FIG. 3, unlike Comparative Example 1 and Comparative Example 5, Example 1 and Comparative Example 2 each appear to have particles that are significantly larger due to the first coating layer comprising the thermally conductive material. In addition, when comparing Example 1 and Comparative Example 2, it may be seen that nano-scale particles with smaller particle sizes are densely coated due to the lithium-affinitive material included in the second coating layer in Example 1.

### Experimental Example 2

In this experiment, the influence of the second coating layer comprising the lithium-affinitive material was analyzed.

To this end, the coating thickness of the separators of Comparative Examples 3 to 5 was first measured. The thickness was measured using an Alpha-step height measurement device.

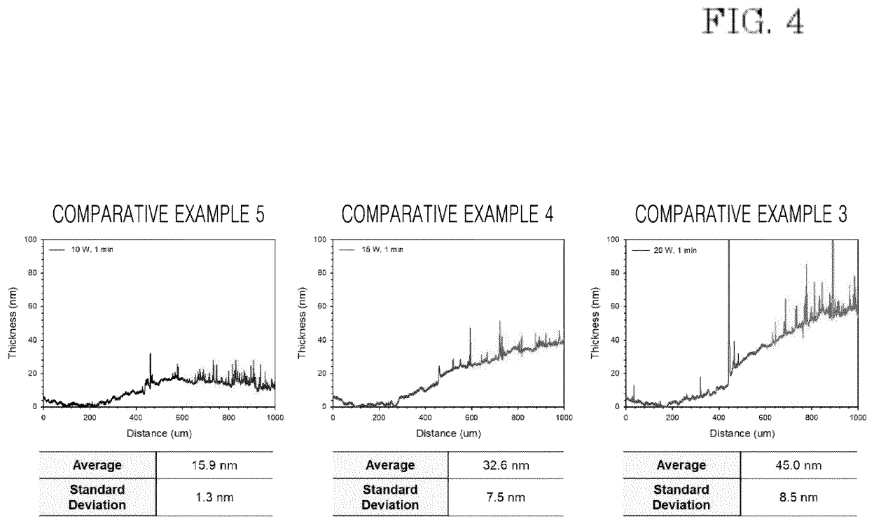

The results are shown in Table 2 and in FIG. 4.

TABLE 2

| | Average | Standard |
|---|---|---|
| | thickness (nm) | deviation (nm) |
| Comparative Example 3 | 45.0 | 8.5 |
| Comparative Example 4 | 32.6 | 7.5 |
| Comparative Example 5 | 15.9 | 1.3 |

Referring to Table 2 and FIG. 4, it may be seen that the coating thickness increases as the output increases during the sputtering process for forming the second coating layer.

Next, the electrochemical characteristics of the separators of Comparative Example 1 and Comparative Examples 3 to 5 were analyzed.

To this end, a symmetric cell using Li metal was manufactured to prepare the lithium secondary battery, and the electrochemical performance according to the thickness of the second coating layer was compared by measuring the change in voltage over time.

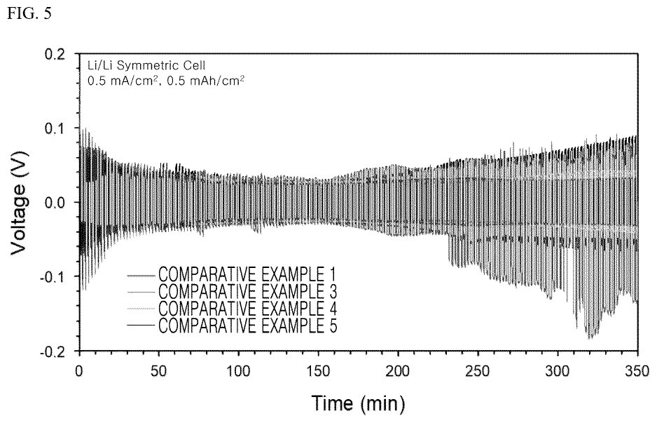

The results are illustrated in FIG. 5.

Referring to FIG. 5, it may be seen that Comparative Example 3 exhibited a large resistance compared to Comparative Example 1. It can also be observed that Comparative Examples 4 and 5 exhibited excellent life characteristics because the overall overvoltage was formed lower than Comparative Example 1.

Referring to FIGS. 4 and 5, the data suggests that the thickness of the second coating layer may advantageously range from 10 to 40 nm which may minimize the increase in resistance due to the coating layer. In addition, in the case of Example 1, the sputtering process was performed with an output of 10 W as in Comparative Example 5, so it may be determined that the thickness of the coating layer was formed similarly to Comparative Example 5 to obtain the excellent electrochemical characteristics.

### Experimental Example 3

In this experiment, the thermal conductivity characteristics of the separators of Example 1, Comparative Example 1, and Comparative Example 2 were measured. The thermal conductivity characteristics were analyzed by irradiating the surface of the separator with a laser and then checking the thermal behavior in real time using an IR camera.

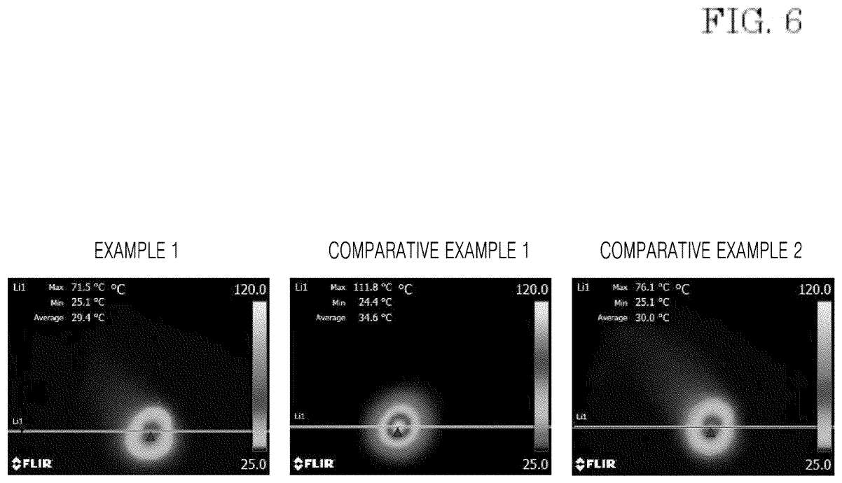

The results are shown in Table 3 and FIG. 6.

TABLE 3

| | | Comparative | Comparative |
|---|---|---|---|
| | Example 1 | Example 1 | Example 2 |
| Maximum | 71.5 | 111.8 | 76.1 |
| temperature (° C.) | | | |
| Average temperature | 25.1 | 24.4 | 25.1 |
| (° C.) | | | |

Referring to Table 3 and FIG. 6, it may be seen that the maximum temperature of the separators of Example 1 and Comparative Example 2 was measured lower than that of Comparative Example 1. This indicates that the thermal conductivity characteristics may be excellent when the first coating layer comprising the thermally conductive material is included. In addition, since Example 1 had a lower maximum temperature value than Comparative Example 2, the data infers that an additional effect may be due to the second coating layer.

### Experimental Example 4

In this experiment, the electrochemical characteristics of the separators of Example 1, Comparative Example 1, Comparative Example 2, and Comparative Example 5 were measured. To this end, a lithium secondary battery was manufactured using NMC622 as the cathode and Li metal as the anode. Thereafter, the capacity retention according to the rate was measured.

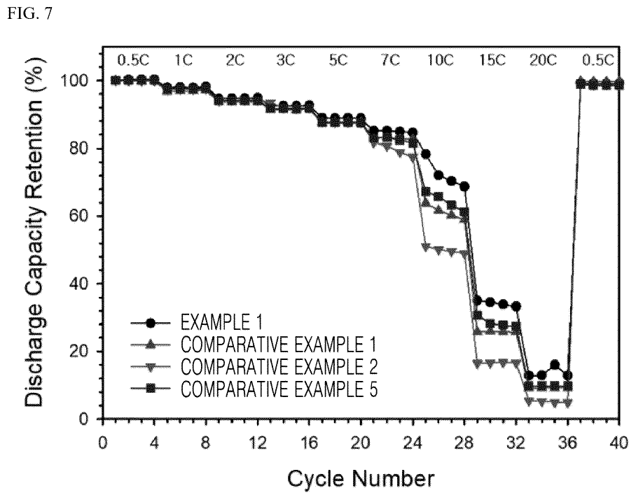

The results were illustrated in FIG. 7.

Referring to FIG. 7, it may be seen that Example 1 has an excellent capacity retention compared to Comparative Examples 1, 2, and 5, and in particular, it may be seen that the high-speed characteristics are excellent. This may be due to the feature of the first and second coating layers (i.e., Example 1 comprising the first coating layer compared to Comparative Example 5; and comprising the second coating layer compared to Comparative Example 2).

The present disclosure has been described with reference to several non-limiting exemplary embodiments. It will be understood by those skilled in the art to which the present disclosure pertains that the present disclosure may be implemented in a modified form without departing from essential characteristics of the present disclosure. Therefore, the embodiments disclosed herein should be considered in an illustrative aspect rather than a restrictive aspect. The scope of the claims are defined by the claims and equivalents thereto, as interpreted in light of the example aspects and embodiments of the present disclosure.

1. A separator for a lithium secondary battery, comprising:
a porous substrate;
a first coating layer coating at least a portion of the porous substrate; and
a second coating layer coating at least a portion of the first coating layer,
wherein the first coating layer comprises a thermally conductive material, and
the second coating layer comprises a lithium-affinitive material.

2. The separator of claim 1, wherein the porous substrate comprises a polyolefin material.

3. The separator of claim 1, wherein the porous substrate has a thickness of 3 to 30 μm and a porosity of 30 to 80%.

4. The separator of claim 1, wherein the thermally conductive material comprises aluminum nitride (AlN), boron nitride (BN), silicon nitride (Si₃N₄), magnesium nitride (Mg₃N₄), silicon carbide (SiC), beryllium oxide (BeO), aluminum oxide (Al₂O₃), aluminum (Al), silver (Ag), gold (Au), copper (Cu), and/or nickel (Ni), or any combination thereof.

5. The separator of claim 4, wherein the thermally conductive material has a thermal conductivity of 20 W/m·K or more.

6. The separator of claim 1, wherein the first coating layer has a thickness of 1 to 10 μm.

7. The separator of claim 1, wherein the lithium-affinitive material comprises gold (Au), silver (Ag), platinum (Pt), zinc (Zn), silicon (Si), magnesium (Mg), copper oxide (CuO), zinc oxide (ZnO), cobalt oxide (CoO), and/or manganese oxide (MnO), or any combination thereof.

8. The separator of claim 1, wherein the second coating layer has a thickness of 10 to 100 nm.

9. The separator of claim 1, wherein the separator for a lithium secondary battery has a thickness of 8 to 15 μm and an ionic conductivity of 0.550 to 0.710 mS cm⁻¹.

10. A lithium secondary battery comprising the separator for a lithium secondary battery according to claim 1.

11. A method for manufacturing a separator for a lithium secondary battery, comprising:
forming a first coating layer comprising a thermally conductive material on at least a portion of a porous substrate; and
forming a second coating layer comprising a lithium-affinitive material on at least a portion the first coating layer.

12. The method of claim 11, wherein the porous substrate comprises a polyolefin material.

13. The method of claim 11, wherein the thermally conductive material comprises aluminum nitride (AlN), boron nitride (BN), silicon nitride (Si₃N₄), magnesium nitride (Mg₃N₄), silicon carbide (SiC), beryllium oxide (BeO), aluminum oxide (Al₂O₃), aluminum (Al), silver (Ag), gold (Au), copper (Cu), and/or nickel (Ni), or any combination thereof.

14. The method of claim 11, wherein the lithium-affinitive material comprises gold (Au), silver (Ag), platinum (Pt), zinc (Zn), silicon (Si), magnesium (Mg), copper oxide (CuO), zinc oxide (ZnO), cobalt oxide (CoO), and/or manganese oxide (MnO), or any combination thereof.

15. The method of claim 11, wherein forming the first coating layer comprises bar-coating a mixture comprising a binder, a solvent, and the thermally conductive material on the porous substrate, and
the mixture comprises the thermally conductive material and the binder in a mass ratio of 8:1 to 10:1.

16. The method of claim 15, wherein the binder is polyvinylidene fluoride (PVDF), and the solvent is N-methyl pyrrolidone (NMP).

17. The method of claim 11, wherein forming of the second coating layer on the first coating layer comprises a sputtering process using the lithium-affinitive material as a target material and is performed at an output of 10 to 20 W.

18. The method of claim 11, wherein the forming of the second coating layer provides a thickness of the second coating layer of 10 to 100 nm.

19. The separator of claim 1, wherein the thermally conductive material comprises aluminum nitride (AlN) and the lithium-affinitive material comprises silver (Ag).

20. The method of claim 11, wherein the thermally conductive material comprises aluminum nitride (AlN) and the lithium-affinitive material comprises silver (Ag).
